(19) United States
(12) Patent Application Publication
(10) Pub. No.: US 2002/0144976 A1
(43) Pub. Date: Oct. 10, 2002

(54) Method for making a shape in a crystal and crystal product made therefrom

(76) Inventor: Hyuk Dae Kwon, Seoul (KR)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/826,806

(22) Filed: Apr. 6, 2001

(51) Int. Cl. B44C 1/22; C23F 1/00; C03C 15/00

(52) U.S. Cl. 216/66

(57) ABSTRACT

A desired shape is formed in the inside of a workpiece by making a number of bubble-like portions in the inside and positioning the portions close or connecting the portions in a predetermined external appearance. The workpiece is preferably crystal with 22% or more lead oxide. According to the method, the external appearance of the crystal is shaped as a desired form. Then, the crystal is clamped on a treatment table of laser treatment device having three axes orthogonal to each other and a laser beam emitted from the device is divided. Finally, a three-dimensional shape is created by focusing said two laser beams into the inside, creating the neighboring bubble-like portions having an asterisk shape through destruction of foreign substance such as lead oxide by a heat produced from the focused laser beam.

### FIELD OF THE INVENTION

The invention relates to a method for making a desired shape and form in a crystal and a crystal product mode therefrom.

### BACKGROUND OF THE INVENTION

As a laser beam emitted from a laser has a monochromatic light having a high density, it is possible to make the laser beam a light flux having a very high parallelism, or to focus the laser beam as thin as the wavelength of the laser beam using an optical system.

Such characteristics of the laser beam are widely used. For example, such uses include a standard spectrum source, a laser interferometer, a laser holographic, precision measurement, precision positioning, speed detection, laser communication, laser recording, display, and medical appliance using the laser beam, etc.

In addition, the laser beam is used in the field of treating the surface of an object by transforming the laser beam into thermal energy.

Although the power of the laser beam is small, it is possible for the laser beam to melt or to evaporate any material by means of focusing the laser beam as thin as possible for increasing the power density of the laser beam.

A treatment using the laser beam has a primary advantage in that the laser beam emitted from a laser treatment apparatus is locally irradiated on a desired portion of a target object and a heat is produced on the portion locally irradiated to cut or to make a groove or hole in that portion, thus treating the object without any contact. Such laser treatment apparatus comprises a laser head, an optical system for focusing the beam, a power supply, a monitor for the optical system and a treatment table capable of movement in 3-dimensions.

The laser head comprised a laser rod, a resonator and an optical system for focusing the laser beam to form an optical resonator that pumps active particles in a laser source.

As described hereinbefore, the laser is used in a various industrial fields, but in such uses the treatment of object is limited to surface treatment.

Because it was thought impossible to treat the inside of an object without treating a surface of the object, the object is divided into two or more segments, each segment is treated, then the treated segments are adhered together to form the desired treated inner portion of the object.

However, such treatment methods are undesirable.

### SUMMARY OF THE INVENTION

In the treatment method for treating from the surface to the inner portion of the object, as the surface of the object is treated, in the case of the object placed on exhibition, a particle such as a dust is introduced to the inner portion through the surface. In that case, the inner portion becomes contaminated with the particle and needs to be cleaned, otherwise the value is lost in the case of goods for display.

An object of the present invention is to provide a method for making a shape in a crystal that can treat an inner portion of the object in a desired shape without treating a surface of object, and a crystal produced therefrom.

In order to achieve this object, a method for treating the inside of the crystal is provided, said method comprising: a step of dividing a laser beam in two beams; a step of projecting the two beams into a workpiece; and a step of focusing the projected beams in the inside of the workpiece to form a bubble-like portion in the form an asterisk dot in the inside by means of thermal collapse of the workpiece material produced on the focused portion and at the same time moving the workpiece in the x, y and z directions to form a 3-dimensional shape comprised of number of said asterisk dots.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a flowchart for illustrating a process of making a shape shown as a bubble in the inside of crystal according to the present invention;

FIG. 2 is a diagram showing the relationship between the position of crystal and a laser beam emitted from a laser device making the shape in the inside in accordance with the present invention;

FIG. 3a is a photographic image of a crystal product formed according to the present invention; and

FIG. 3b is a plan view of a crystal product formed according to the present invention.

### DETAILED DESCRIPTION OF THE INVENTION

The present invention will now be described more fully hereinafter with reference to the accompanying drawings, in which preferred embodiments of the invention are shown.

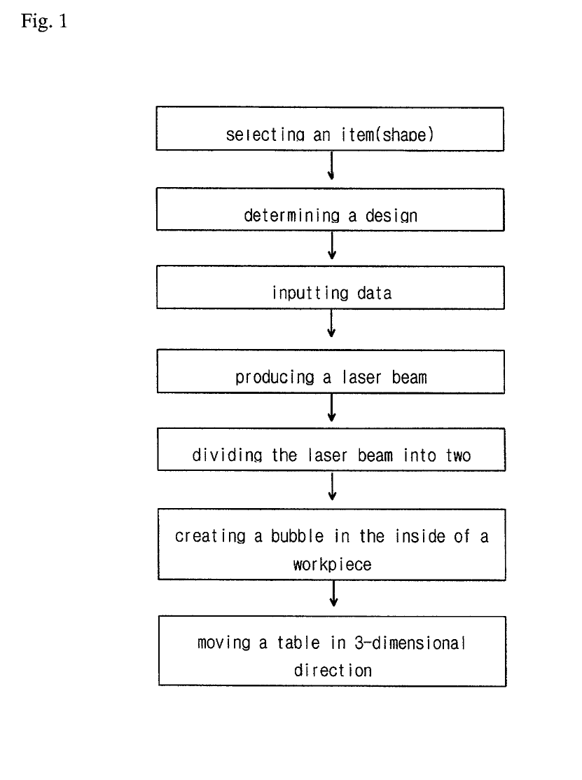

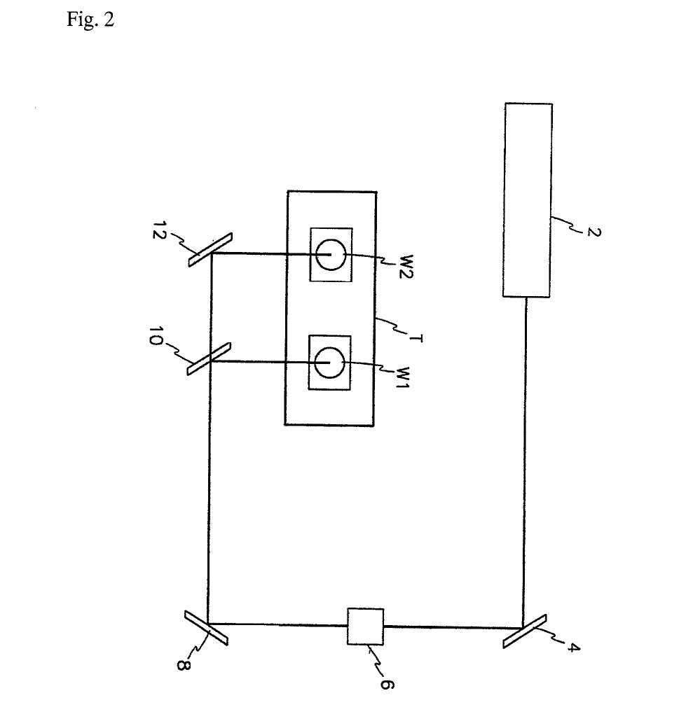

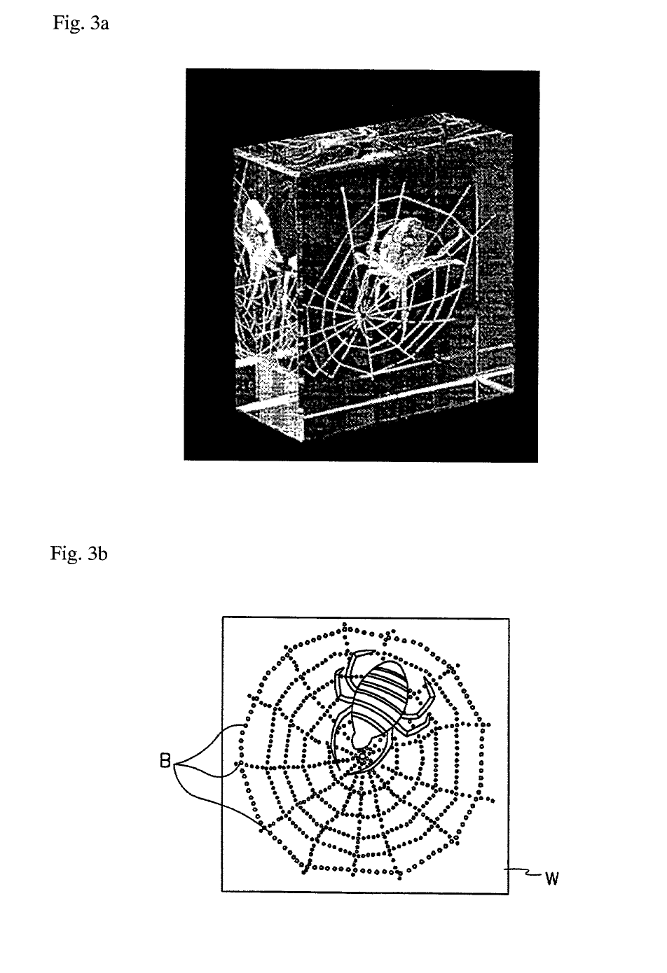

FIG. 1 is a flowchart for illustrating a process of making a shape shown as a bubble in the inside of crystal according to the present invention. FIG. 2 is a diagram showing the relationship between the position of crystal and a laser beam emitted from a laser treatment device making the shape in the inside in accordance with the present invention.

A workpiece used in the present invention is preferably a transparent crystal including 22% or more lead oxide, and capable of absorbing the laser beam. A crystal including less than 22% lead oxide does not absorb the laser beam sufficiently and, if the crystal is not transparent, the shape formed in the inside does not project out sufficiently.

First, an item shape is selected. Then, a 3-dimensional design for the item to be formed in the inside of the crystal is determined.

When the 3-dimensional design is determined, data for the 3-dimensional design is inputted to a control part of the laser treatment apparatus. Said procedures are performed using a conventional method known to the art.

Then, the crystal formed in the desired shape is clamped on a treatment table of the laser treatment device and a laser beam is generated.

FIG. 2 illustrates a laser beam path through which the laser is emitted from a laser head (2) of the laser treatment device and sent to a workpiece (crystal) W.

A first reflection mirror (4) for changing the direction of the laser beam is positioned in the laser beam path. After the laser beam has its direction changed by the first mirror (4), it is passed through a magnifying and collimating means (6) and directed exactly to a treatment position.

The laser beam passed through the magnifying and collimating means (6) is reflected again by a second reflection mirror (8) to change its direction and divided by a beam splitter (10) mounted in the laser beam path.

A first laser beam and a second laser beam that are divided are projected on the workpieces (W1, W2) clamped on the table. The workpieces are preferably made from the above-mentioned crystal including lead oxide.

An appropriate positioning relationship between the mirrors is in effective to decrease an occupying space of the device.

Said two laser beams are absorbed by a foreign substance included in the crystal to produce heat, which destroys the foreign substance to create a bubble-like portion seen as an asterisk. The laser head has a conventional optical system for focusing the laser beam.

In order to make the bubble-like portion in the inside of crystal by injecting the laser beam into the inside of crystal, the smoothness of the surface of crystal should be high. It is well understood that the bubble-like portion is formed best in the case of the laser beam having a wavelength of 632.8 nm, because said wavelength is absorbed best by a foreign substance, such as lead oxide, to create the substance or asterisk.

A YAG laser using Nd as the active particle produces a laser beam having a wavelength of 1065 nm, such wavelength is, however, transformed to 632.8 nm via Q-switching to be used in treating of the inside of the crystal.

The treatment table T in moved in the x, y and z directions while treating the inside of crystal, the laser beam is injected into a predetermined portion, the bubble-like portions are continuously produced in the workpiece in 3-dimensions.

It is required to control the laser treatment device in order to focus the laser beam into the inside of crystal. Such focusing the laser beam is well known to the art and its detailed description is omitted.

FIG. 4a is a photograph showing a hexagonal crystal having a shape of a spider making a cobweb formed therein.

As well understood from FIG. 4a, it is possible to make a desired shape in the inside of crystal without giving damage to the surface of crystal. As shown in FIG. 4b, a number of neighboring bubble-like portions define the desired shape.

Although the shape of the crystal shown in the photography is a hexahedron, the shape is not limited to the hexahedron but could be a circle, an oval, etc. The design to be formed in the inside of crystal is depend on an initial design. Namely, any shape can be formed in the inside of crystal.

As described hereinbefore, with the method according to the present invention, it is possible to treat the inside of crystal without a damage of the surface of crystal by focusing the laser beam having high energy into a predetermined point in the inside of crystal, creating the bubble-like portion by means of destroying the point by the heat produced from the laser beam while moving the treatment table and making 3-dimensional shape formed by the neighboring bubble-like portion. Therefore, it is possible to eliminate disadvantages of prior art.

Although preferred embodiments of the method and apparatus of the present invention have been illustrated in the accompanying drawings and described in the foregoing description, it is understood that the invention is not limited to the embodiment(s) disclosed but it capable of numerous rearrangements, modifications and substitutions without departing from the spirit of the invention as set forth and defined in the following claims.

1. A method for treating the inside of an object, said method comprising:
focusing a laser beam emitted from a laser into a predetermined point in the inside of the object; and
creating a bubble-like portion in the predetermined point by destroying the predetermined point using a heat produced from the focused laser beam while moving the object clamped on a treatment table in x, y and z directions to make a 3-dimensional shape comprised of a number of the bubble-like portions.

2. The method according to claim 1, wherein said object is a crystal including 22% or more lead oxide.

3. The method according to claim 1, wherein the laser beam has a wavelength of 632.8 nm.

4. The method according to claim 1, wherein the destroyed point comprises an asterisk shape.

5. A crystal product including 22% or more lead oxide having a number of neighboring bubble-like portions positioned as 3-dimensional shape therein.
